(19) United States
(12) Patent Application Publication
(10) Pub. No.: US 2014/0285511 A1
(43) Pub. Date: Sep. 25, 2014

(54) IMAGE DISPLAY APPARATUS AND CONTROL METHOD THEREFOR

(71) Applicant: CANON KABUSHIKI KAISHA, Tokyo (JP)

(72) Inventor: Hironobu Hoshino, Machida-shi (JP)

(73) Assignee: CANON KABUSHIKI KAISHA, Tokyo (JP)

(21) Appl. No.: 14/207,857

(22) Filed: Mar. 13, 2014

(30) Foreign Application Priority Data
Mar. 19, 2013 (JP) 2013-056904

(51) Int. Cl. G06T 11/00

(52) U.S. Cl. CPC G06T 11/001
USPC 345/590

(57) ABSTRACT

An image display apparatus includes a display unit having a plurality of pixels each composed of subpixels and being configured to display an image based on image data by causing light from a light source to transmit through the subpixels at a transmittance set for each subpixel, a setting unit configured to set the transmittance of each subpixel according to a pixel value of each pixel of the image data, and an acquisition unit configured to acquire the brightness of the light having transmitted through each pixel, wherein the setting unit corrects the transmittance of each subpixel in such a manner that with respect to a pixel of which the brightness of the transmitted light is equal to or greater than a threshold value, a difference between the color of the transmitted light and a target color based on the pixel value thereof becomes small.

### BACKGROUND OF THE INVENTION

1. Field of the Invention

The present invention relates to an image display apparatus and a control method therefor.

2. Description of the Related Art

At present, image display apparatuses are required in which an image is made easy to see by making the ratio of brightness and darkness (contrast ratio) between a bright image region and a dark image region thereof as large or high as possible.

There is a local dimming technology in which the contrast ratio of image display is increased by turning on a backlight with high brightness (luminance) while enhancing the transmittance of a liquid crystal panel in a bright image region, and by turning on the backlight with low brightness (luminance) while lowering the transmittance of the liquid crystal panel in a dark image region (for example, a Japanese patent application laid-open No. 2010-107535).

On the other hand, it is generally known that the eyes of a human being will change in sensitivity according to visual environment. For example, it is known that under a bright environment, the human eyes will be in a state of photopic vision in which cone cells become dominant and easy to sense color.

In addition, it is also known that under a dark environment, the human eyes will be in a state of scotopic vision in which rod cells become more dominant rather than the cone cells, so luminance sensitivity becomes high, but color sensitivity becomes low. It is further known that under a scotopic or dim environment which is neither a bright field nor a dark field, luminance sensitivity and color sensitivity will be in a state of mesopic vision which is between scotopic vision and photopic vision.

### SUMMARY OF THE INVENTION

With the liquid crystal panel, when its transmittance is lowered due to the optical properties of a liquid crystal, an optical film, a polarizing plate, etc., the color of transmitted light may change. For example, even if an achromatic or achromatic color image is displayed, it may look blue. In cases where the luminance of the backlight in a region of the liquid crystal panel in which the transmittance thereof has been decreased is low, it will be in the state of scotopic vision, and in this case, the color sensitivity of a viewer becomes low, so the viewer can permit this color shift (i.e., can not perceive it). However, in cases where the luminance of the backlight in the region in which the transmittance thereof has been lowered is high, it will be in the state of photopic vision or mesopic vision, and in this case, the color sensitivity of the viewer becomes high, so that the viewer can perceive this color shift, and a strange or uncomfortable feeling may be generated.

Here, in the image display apparatus which carries out local dimming, the backlight is composed of a plurality of light emitting areas, and the luminance in each of the light emitting areas is controlled according to the brightness of an image corresponding to each light emitting area. In cases where a high brightness area and a low brightness area are adjacent to each other, light may leak from the high brightness area to the low brightness area, so that the luminance of the low brightness area may go up. The low brightness area is a region where a dark image is displayed and the transmittance of the liquid crystal panel is lowered, and hence, the color of transmitted light changes as stated above. As the luminance of the low brightness area goes up due to the light leakage, the viewer becomes able to perceive this color shift. For that reason, there has been a case where when an achromatic or achromatic color image (monochrome image) having a bright image portion and a dark image portion arranged adjacent to each other is displayed, a false color may occur in which the dark image portion becomes blue, thus causing the viewer to have a strange or uncomfortable feeling.

Accordingly, an object of the present invention is to reduce a strange or uncomfortable feeling which a viewer has, due to a color shift of display color in an image display apparatus.

A first aspect of the present invention resides in an image display apparatus which comprises:

a display unit having a plurality of pixels each composed of subpixels of a plurality of colors and being configured to display an image based on inputted image data by causing light from a light source to transmit through the subpixels at a transmittance set for each subpixel;

a setting unit configured to set the transmittance of each subpixel of said display unit according to a pixel value of each pixel of said image data; and

an acquisition unit configured to acquire the brightness of the light having transmitted through each pixel of said display unit;

wherein said setting unit corrects the transmittance of each subpixel in such a manner that with respect to a pixel of which the brightness of the transmitted light is equal to or greater than a threshold value, a difference between the color of the transmitted light and a target color based on the pixel value thereof becomes small.

A second aspect of the present invention resides in a control method for an image display apparatus comprising a display unit having a plurality of pixels each composed of subpixels of a plurality of colors and being configured to display an image based on inputted image data by causing light from a light source to transmit through the subpixels at a transmittance set for each subpixel, said method comprising:

setting the transmittance of each subpixel of said display unit according to a pixel value of each pixel of said image data; and

acquiring brightness of the light having transmitted through each pixel of said display unit;

wherein in said setting, the transmittance of each subpixel is corrected in such a manner that with respect to a pixel of which the brightness of the transmitted light is equal to or greater than a threshold value, a difference between the color of the transmitted light and a target color based on the pixel value thereof becomes small.

In the present invention, it is possible to reduce a strange or uncomfortable feeling which a viewer has, due to a color shift of display color in an image display apparatus.

Further features of the present invention will become apparent from the following description of exemplary embodiments with reference to the attached drawings.

### BRIEF DESCRIPTION OF THE DRAWINGS

FIG. 1 is a view showing the construction of an image display apparatus according to an embodiment of the present invention.

FIG. 2A and FIG. 2B are views explaining the function of a liquid crystal panel according to the embodiment of the present invention.

FIG. 3A and FIG. 3B are views explaining the relation between a light source and the liquid crystal panel according to the embodiment of the present invention.

FIG. 4A through FIG. 4E are views explaining data stored in a storage unit according to the embodiment of the present invention.

FIG. 5 is a flow chart for explaining control of a liquid crystal control unit according to the embodiment of the present invention.

### DESCRIPTION OF THE EMBODIMENTS

### First Embodiment

A first embodiment of the present invention describes an embodiment which, in an image display apparatus which carries out local dimming, the generation of false color is suppressed by carrying out color correction control in consideration of leakage light leaking from a light emitting area of high brightness to a light emitting area of low brightness.

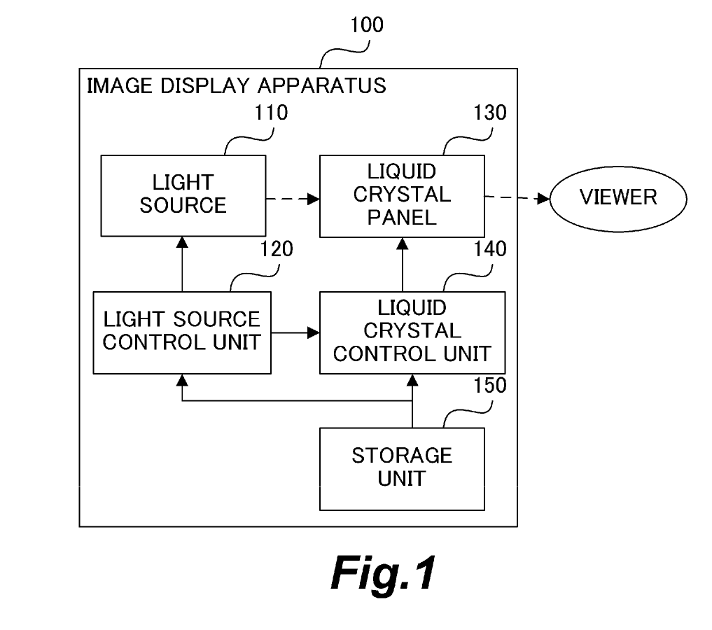

FIG. 1 shows the construction of the image display apparatus according to the embodiment of the present invention.

The image display apparatus 100 in FIG. 1 is provided with a light source 110, a light source control unit 120, a liquid crystal panel 130, a liquid crystal control unit 140, and a storage unit 150.

The light source 110 irradiates the liquid crystal panel 130. The light source 110 is composed of light emitting diodes (a white LED, three primary color LEDs), a cold cathode tube, an organic EL device, a halogen lamp, etc. The light source 110 may be constructed such that it emits light through a light guide member such as a lens, a light guide plate, etc. The light source 110 of this embodiment is assumed to be a light source which is composed of a white LED with an optical property capable of irradiating uniform light to the liquid crystal panel 130 right above it, and a light guide plate. In addition, an amount of light emission of the light source 110 is controlled by the light source control unit 120. As a result of this, it is possible to change an amount of light to be irradiated on the liquid crystal panel 130 by means of the light source 110.

The light source control unit 120 has a function to change the electric power to be supplied to the light source 110 thereby to regulate the amount of light emission of the light source 110. In addition, the light source 110 is composed of a plurality of light emitting areas which can be individually controlled in emission. The light source control unit 120 has a local dimming function to regulate an amount of light emission of the light source 110 for each of the light emitting areas according to image data stored in the storage unit 150. In this embodiment, the liquid crystal panel 130 has a display region composed of a plurality of display areas, wherein the individual light emitting areas of the light source 110 correspond to the individual display areas of the liquid crystal panel 130, respectively. The light source control unit 120 controls the amount of light emission of each light emitting area according to a maximum gradation value of image data in each corresponding display area. The light source control unit 120 notifies the liquid crystal control unit 140 of an amount of light with which each display area of the liquid crystal panel 130 is irradiated from the light source 110. Although in this embodiment, an example is described in which the amount of light emission of the light source is adjusted by adjusting an amount of electric current to be supplied to the light source 110, the amount of light emission may instead be adjusted by means of pulse width modulation (PWM) control which regulates a light emission period (a turn-on period of time) per unit time.

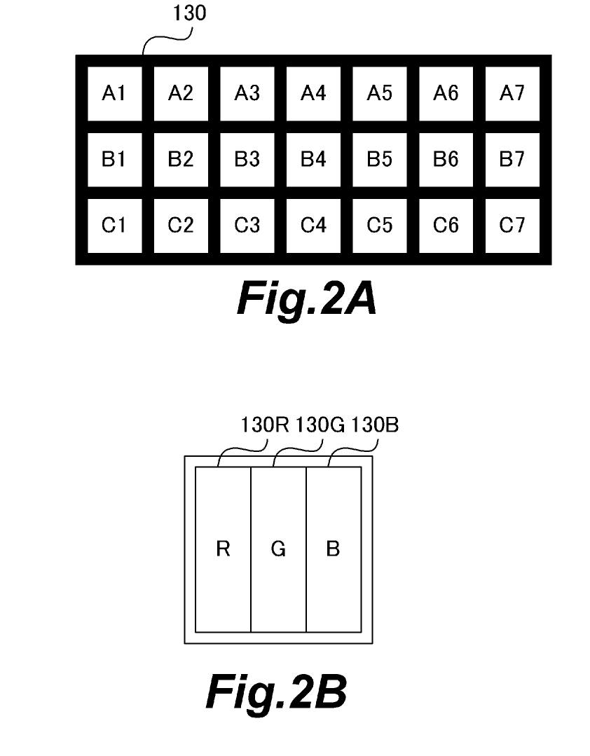

FIG. 2A and FIG. 2B are views explaining the function of the liquid crystal panel 130 according to the embodiment of the present invention. The liquid crystal panel 130 is a transmissive liquid crystal panel which receives, on a surface opposite to the viewer, the light irradiated from the light source 110 and regulates an amount of light which is caused to be transmitted to a viewer side in each of vertically and horizontally divided regions thereof (hereinafter referred to as pixels). The display panel 130 has a plurality of pixels each composed of subpixels of a plurality of colors, and displays an image based on inputted image data by causing the light from the light source 110 to transmit through the subpixels at a transmittance set for each subpixel. In this embodiment, the liquid crystal panel 130 is divided into 3 parts in the vertical direction and into 7 parts in the horizontal direction so as to have a total of 21 pixels A1-A7, B1-B7, and C1-C7, as shown in FIG. 2A. Further, each pixel is composed of a plurality of regions 130R, 130G and 130B (hereinafter subpixels) in which transmission spectral characteristics are different from one another so that the color of light to be emitted therefrom can be changed, as shown in FIG. 2B, thereby making it possible to regulate the transmittances of the individual subpixels independently of one another. For example, the subpixel 130R has a color filter of red color, and when the transmittance of the subpixel 130R is changed, the amount of transmitted light of red color passing therethrough can be regulated. Similarly, the amount of transmitted light of green color can be regulated with the subpixel 130G, and the amount of transmitted light of blue color can be regulated by the subpixel 130B.

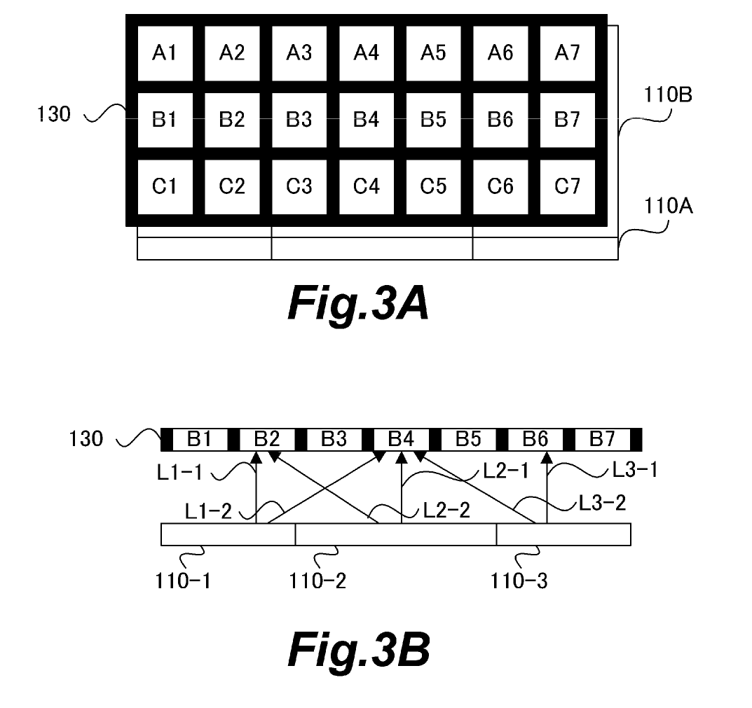

With this construction, the liquid crystal panel 130 can display the image at a resolution equal to the number of pixels, by adjusting the transmittances of each pixel and each subpixel based on an instruction from the liquid crystal control unit 140. In addition, a display color can be corrected by adjusting the transmittances of each pixel and each subpixel. Here, the relation between the light source 110 and the liquid crystal panel 130 will be described in detail by the use of FIG. 3A and FIG. 3B. As shown in FIG. 3A, the light source 110 disposed at the back surface of the liquid crystal panel 130 is composed of a light guide plate 110B and an LED 110A.

In this embodiment, the liquid crystal panel 130 is formed of three display areas. A first display area is composed of pixels A1, A2, B1, B2, C1 and C2; a second display area is composed of pixels A3-A5, B3-B5 and C3-C5; and a third display area is composed of pixels A6, A7, B6, B7, C6 and C7. The light source 110 is formed of three light emitting areas corresponding to the three display areas of the liquid crystal panel 130, respectively. FIG. 3B is a view showing the cross sections of the liquid crystal panel 130 and the light source 110 according to a cross section vertical to the plane of the view in a row of pixels B1-B7 in FIG. 3A. As shown in FIG. 3B, a light guide plate in a light emitting area 110-1 is located in match with the positions of the pixels B1-B2 of the liquid crystal panel 130. In addition, a light guide plate in a light emitting area 110-2 is located in match with the positions of the pixels B3-B5 of the liquid crystal panel 130. Moreover, a light guide plate in a light emitting area 110-3 is located in match with the positions of the pixels B6-B7 of the liquid crystal panel 130.

The light source control unit 120 controls the light source 110 in such a manner that a light emitting area located directly beneath each display area of the liquid crystal panel 130 emits light with an amount of light emission corresponding to a maximum gradation value of an image to be displayed in the display area of the liquid crystal panel 130. The light from the light source 110 is irradiated on the liquid crystal panel 130 by means of the light guide plates. As a result, the viewer becomes possible to visually recognize or view the image displayed on the liquid crystal panel 130.

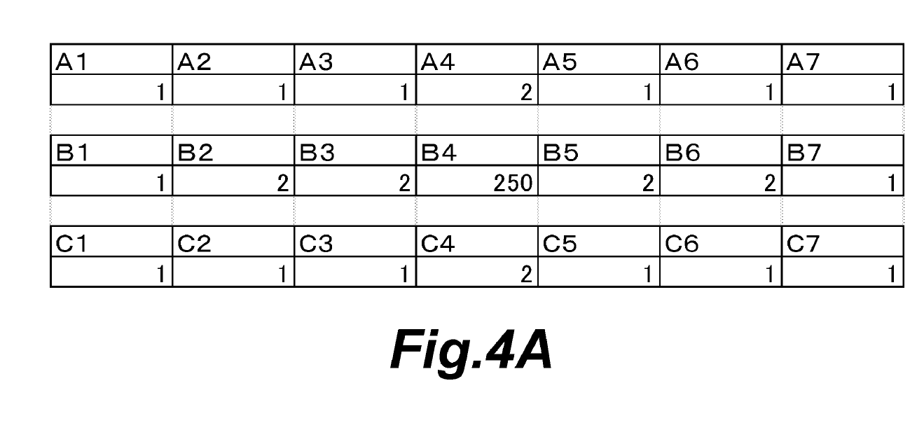

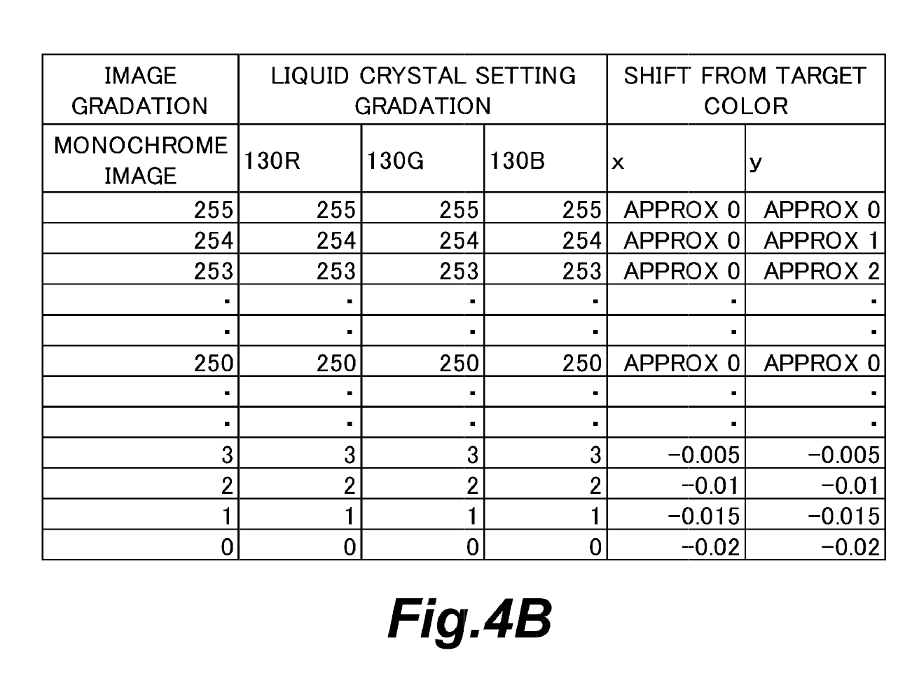

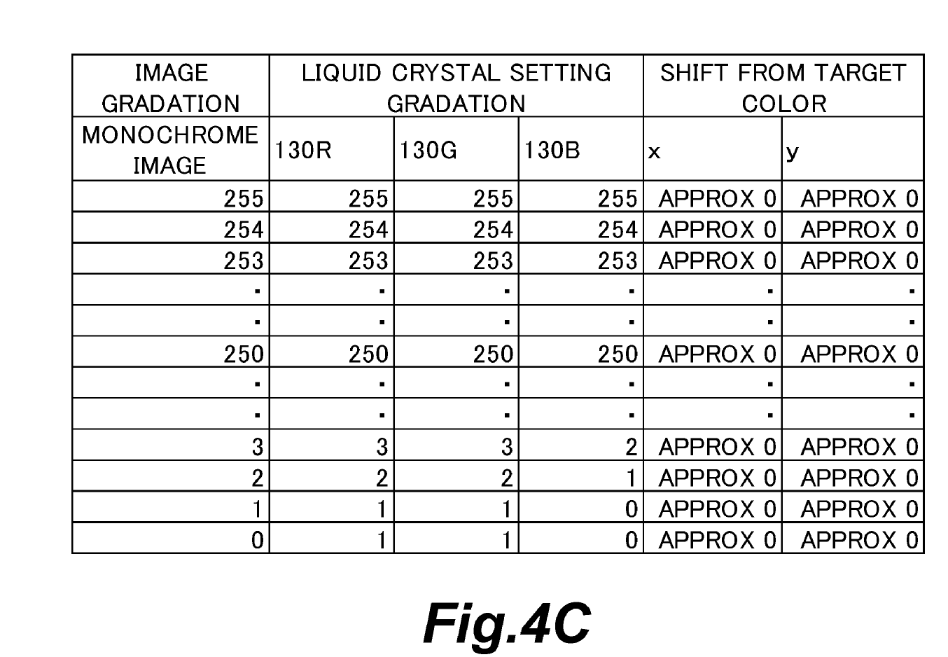

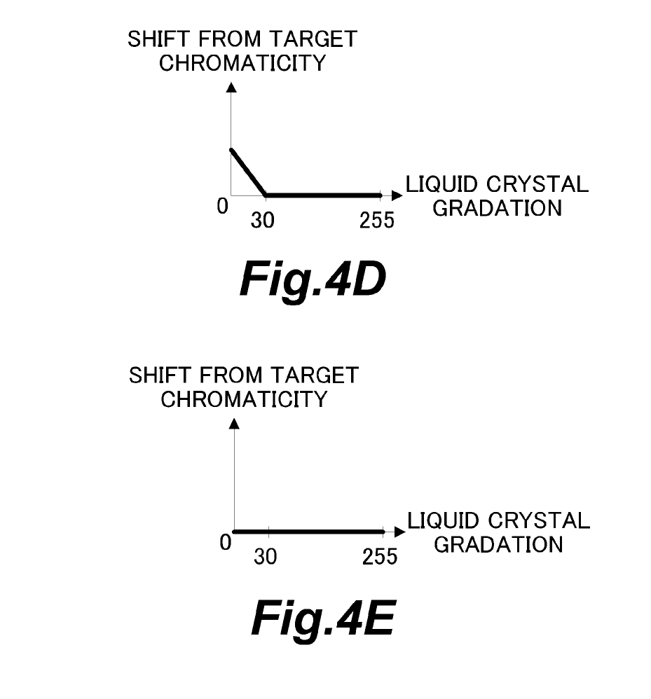

FIG. 4A through FIG. 4E are views explaining an example of data stored in the storage unit 150 according to the embodiment of the present invention. The storage unit 150 has stored image data to be displayed on the liquid crystal panel 130, as shown in FIG. 4A. In addition, the storage unit 150 has stored a plurality of pieces of information (transmittance setting parameters) on the correspondence relation in which the transmittance of each subpixel of the liquid crystal panel 130 is set according to the pixel value thereof, as shown in FIG. 4B and FIG. 4C. The image data and the transmittance setting parameters are sent to the liquid crystal control unit 140 according to a request of the liquid crystal control unit 140. In this embodiment, for the sake of simplified explanation, the image data and the transmittance setting parameters in FIG. 4B and FIG. 4C, respectively, stored in the storage unit 150 will be explained as data which represents a pixel value of each pixel of an achromatic color (black and white) image having a gamma (γ)=1.0, by means of a gradation value of 8 bits. However, the image data and the transmittance setting parameters are just an example, and for example, a color image may be used, or the gamma or the bit number of the gradation value may be different from this example.

Here, the image data in FIG. 4A will be explained in detail. The image data is image data of a monochrome image which represents the gradation values of the pixels A1-A7, B1-B7 and C1-C7 with 8 bits. For example, the gradation value of the pixel A1 is 1, so the luminance of the pixel A1 is 1/255 of a maximum luminance. In addition, because the gradation value of the central pixel B4 is 250, the luminance of the pixel B4 is 250/255 of the maximum luminance, and is 250 times the luminance of the pixel A1. Also, because the gradation values of the pixels A4, B2, B3, B5, B6 and C4 are each 2, the luminances of these pixels are each 2/255 of the maximum luminance, and the luminances of these pixels are each twice the luminance of the pixel A1.

Here, the transmittance setting parameters shown in FIG. 4B and FIG. 4B will be explained in detail. A plurality of kinds of transmittance setting parameters are set according to the amount of light to be irradiated on each pixel of the liquid crystal panel 130. Although here will be described, by way of example, a case where two kinds of transmittance setting parameters as shown in FIG. 4B and FIG. 4C have been set, three or more kinds of transmittance setting parameters may have been set in advance according to the amount of light, and stored in the storage unit 150.

In this embodiment, it is assumed that the transmittance setting parameters (first correspondence relation) in FIG. 4B are applied by default at the time of displaying an image.

A leftmost column in FIG. 4B shows the gradation values of image data of a monochrome image. In addition, the columns 130R, 130G, and 130B to the right-hand side thereof represent the transmittances of individual subpixels, respectively, of the liquid crystal panel 130 which are set according to the gradation values of the image data of the monochrome image. Moreover, a column for a shift from a target color at the right-hand side thereof represents an amount of shift (difference) from the target color based on the pixel value of the color of transmitted light. This amount of shift represents a value in a CIE chromaticity diagram drawn up and decided in 1931 by International Commission on Illumination (CIE) (Commission Internationale de l'Eclairage). In cases where the amount of shift from the target color is not about 0, it is shown that the color of the light transmitted through the liquid crystal panel 130 has changed with respect to the target color.

For example, image data of the pixel B4 in the liquid crystal panel 130 has a gradation value of 250, and according to this gradation value, the transmittance of each of the subpixels 130R, 130G, 130B of the pixel B4 is set to 250/255 from the correspondence relation in FIG. 4B. Also, image data of the pixel B2 has a gradation value of 2, and the transmittance of each of the subpixels 130R, 130G, 130B of the pixel B2 is set to 2/255 according to this gradation value.

FIG. 4D shows the relation between the gradation value of image data of the liquid crystal panel 130 and the amount of shift from its target color, in cases where the transmittances of individual subpixels of the liquid crystal panel 130 are set according to the transmittance setting parameters in FIG. 4B. As shown in FIG. 4D, in the case of applying the transmittance setting parameters in FIG. 4B, in low gradation (gray level), the color of the light transmitted through the liquid crystal panel 130 shifts from its target color.

The transmittance setting parameters (second correspondence relation) in FIG. 4C are those which are applied in cases where the luminance of the light transmitted through the liquid crystal panel 130 is a luminance at which the visual level of the viewer is in photopic vision or mesopic vision, and in cases where the color sensitivity of the viewer is high. At the luminance at which the visual level of the viewer is in photopic vision or mesopic vision, it is easy for the viewer to perceive a color shift of the transmitted light, and accordingly, a tolerance or maximum permissible amount of color shift is small. The numerical values in each row in FIG. 4C represent a gradation value of image data, liquid crystal transmittances of subpixels according to the gradation value, and an amount of shift in the color of transmitted light from a target color, respectively, similar to FIG. 4B.

The transmittance setting parameters in FIG. 4C are set such that the amount of shift in the color of the light transmitted through the liquid crystal from its target color in low gradation or gray level becomes smaller than in the case where the transmittance setting parameters in FIG. 4B are applied. FIG. 4E shows the relation between the gradation value of image data of the liquid crystal panel 130 and the amount of shift from its target color, in cases where the transmittances of individual subpixels of the liquid crystal panel 130 are set according to the transmittance setting parameters in FIG. 4C. In cases where the transmittance setting parameters in FIG. 4C are applied in the control of the liquid crystal panel 130, as shown in FIG. 4E, in the low gradation or gray level, too, the amount of shift in the color of the transmitted light is small, and becomes within an allowable range. In this embodiment, in cases where a transmittance is set by the use of the transmittance setting parameters in FIG. 4B, gradation accuracy of the transmittance is higher, as compared with the case where the transmittance is set by the use of the transmittance setting parameters in FIG. 4C. On the other hand, in cases where a transmittance is set by the use of the transmittance setting parameters in FIG. 4C, a difference between the color of the transmitted light and its target color based on the pixel value is small in particular in the low gradation region, as compared with the case where the transmittance is set by the use of the transmittance setting parameters in FIG. 4B.

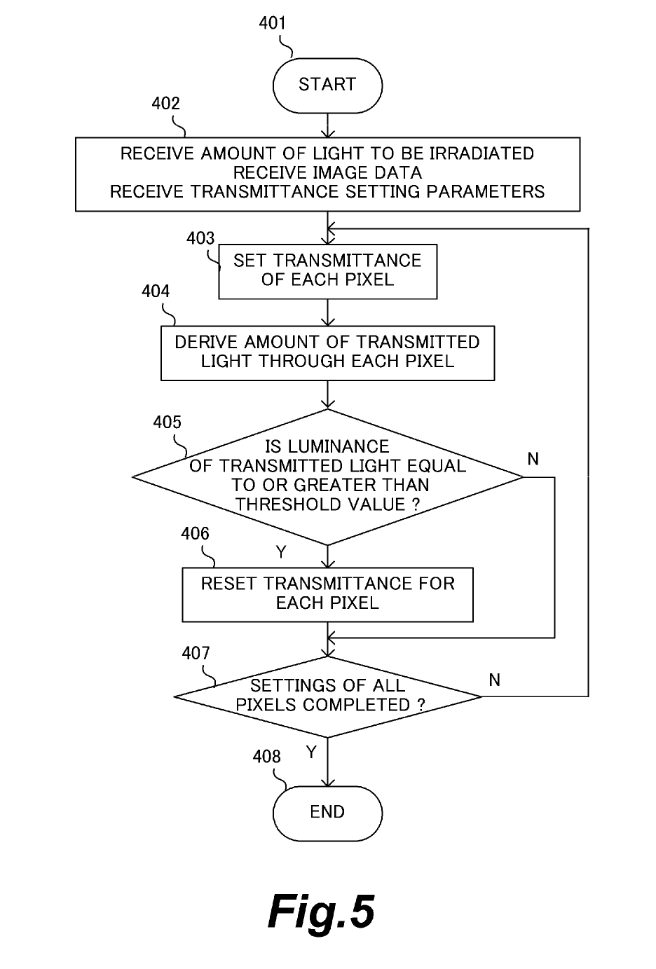

The liquid crystal control unit 140 acquires information on the amount of light irradiated on the liquid crystal panel 130 from the light source control unit 120, and also acquires from the storage unit 150 the image data to be displayed and the transmittance setting parameters to be used for setting the transmittances of the liquid crystal panel 130. In addition, the liquid crystal control unit 140 determines whether the luminance of the light transmitted through the liquid crystal panel 130 is equal to or greater than a threshold value. The threshold value can be set based on the relation between viewer's sensitivity with respect to color and the luminance. For example, the threshold value is set to a boundary luminance value between a luminance value at which photopic vision or mesopic vision occurs for the viewer, and a luminance value at which scotopic vision occurs for the viewer. Moreover, the threshold value is set based on an upper limit of an amount of color shift permitted for the light transmitted through the liquid crystal, so that the color shift felt by the viewer becomes within the allowable range. Thus, under the condition that the color sensitivity of the viewer becomes low, even if there is a certain amount of color shift, it is difficult for the viewer to sense such a color shift, so the upper limit of the amount of color shift permitted for the light transmitted through the liquid crystal becomes high. On the other hand, under the condition that the color sensitivity of the viewer becomes high, the viewer will easily sense even a slight or small color shift and have a strange or uncomfortable feeling, so the upper limit of the amount of color shift permitted for the light transmitted through the liquid crystal becomes low. In cases where the luminance of the light transmitted through the liquid crystal panel is equal to or greater than the threshold value, the liquid crystal control unit 140 sends to the liquid crystal panel 130 an instruction to change the transmittance of each subpixel of the liquid crystal panel 130 in a manner such that the color shift felt by the viewer becomes within the allowable range. The processing of this liquid crystal control unit 140 will be described below in detail by the use of FIG. 5.

FIG. 5 is a flow chart for explaining the processing of the liquid crystal control unit 140 according to the embodiment of the present invention. In the flow chart of FIG. 5, control starts from step S401, and ends in step S408, for example, in cases where an instruction to change a displayed image of a liquid crystal display device, or an instruction to change the luminance of the liquid crystal display device, is given by the viewer. In the following, individual steps in this flow chart will be explained in detail.

Step S402 is processing in which the liquid crystal control unit 140 obtains information necessary for its control. In step S402, the liquid crystal control unit 140 acquires information on the amount of light irradiated on the liquid crystal panel 130 from the light source control unit 120, and also acquires from the storage unit 150 information on the image data to be displayed on the liquid crystal panel 130 and the transmittance setting parameters of individual subpixels thereof.

In the image data of FIG. 4A, the amount of light emission in the light emitting area 110-2 of the light source 110 corresponding to a display area including the pixel B4 of a maximum gradation value is made high, so that strong light is irradiated toward the liquid crystal panel 130. The amount of light irradiated by the light emission in the light emitting area 110-2 onto the pixels A3-A5, B3-B5, C3-C5 inside the display area of the liquid crystal panel 130 corresponding to the light emitting area 110-2 is assumed to be 255 cd/m² at each pixel (a main irradiation amount L2-1). In addition, the amount of light irradiated by the light emission in the light emitting area 110-2 onto the pixels A1, A2, A6, A7, B1, B2, B6, B7, C1, C2, C6, C7 outside the display area of the liquid crystal panel 130 corresponding to the light emitting area 110-2 is assumed to be 253 cd/m² (an auxiliary irradiation amount L2-2).

In the image data of FIG. 4A, a maximum gradation value among the pixels A1, A2, B1, B2, C1, C2 is 2. Also, a maximum gradation value among the pixels A6, A7, B6, B7, C6, C7 is 2. The amounts of light emission in the light emitting areas 110-1, 110-3 of the light source 110 corresponding to those display areas of the liquid crystal panel 130 which include these pixels are made low, so that weak light is irradiated toward the liquid crystal panel 130.

The amount of light irradiated by the light emitting area 110-1 onto the pixels A1, A2, B1, B2, C1, C2 inside the display area of the liquid crystal panel 130 corresponding to the light emitting area 110-1 is assumed to be 2 cd/m² at each pixel (a main irradiation amount L1-1). Also, the amount of light irradiated by the light emitting area 110-3 onto the pixels A6, A7, B6, B7, C6, C7 inside the display area of the liquid crystal panel 130 corresponding to the light emitting area 110-3 is assumed to be 2 cd/m² at each pixel (a main irradiation amount L3-1).

The amounts of light to be irradiated by the light emission in the light emitting areas 110-1, 110-3 onto the pixels A3-A5, B3-B5, C3-C5 outside the display areas of the liquid crystal panel 130 corresponding to the light emitting areas 110-1, 110-3 are assumed to be 0 cd/m² at each pixel (auxiliary irradiation amounts L1-2, L3-2). The reason for the assumption that the auxiliary irradiation amounts are 0 cd/m² is that they are sufficiently small as compared with the main irradiation amounts 255 cd/m² irradiated onto the pixels A3-A5, B3-B5, C3-C5.

In this manner, the amount of light with which each of the pixels A1-C7 of the liquid crystal panel 130 is irradiated from the light source 110 is decided by a sum total of a main irradiation amount (Ln-1) of a light emitting area of the light source 110 corresponding to the display area of the liquid crystal panel 130 to which each pixel belongs, and an auxiliary irradiation amount (Lm-2) from the other light emitting areas thereof. In this embodiment, it is assumed that this sum total of the main and auxiliary irradiation light amounts (hereinafter referred to as the sum total irradiation light amount) is equally set to 255 cd/m² at each pixel. Here, a main irradiation amount and an auxiliary irradiation amount by the light emission in a light emitting area 110-x are denoted by Lx-1, Lx-2, respectively.

In addition, in this embodiment, it is also assumed that there exist two kinds of transmittance setting parameters for each subpixel acquired by the liquid crystal control unit 140 according to the luminance of the light transmitted through the liquid crystal panel 130, as stated above. One is transmittance setting parameters used in cases where the luminance of the liquid crystal transmitted light becomes less than a threshold value X and hence is in the state of scotopic vision for the viewer (where the upper limit of the amount of color shift of the transmitted light under which the color shift felt by the viewer becomes in the allowable range is high), as shown in FIG. 4B. The other is transmittance setting parameters used in cases where the luminance of the liquid crystal transmitted light becomes equal to or more than the threshold value X and hence is in the state of photopic vision or mesopic vision occurs for the viewer (where the upper limit of the amount of color shift of the transmitted light under which the color shift felt by the viewer becomes in the allowable range is low), as shown in FIG. 4C.

In step S403, the liquid crystal control unit 140 first sets a transmittance (Bx) of the liquid crystal panel 130 by the use of the image data shown in FIG. 4A and the transmittance setting parameters shown in FIG. 4B. Here, the transmittance of a pixel x is represented as Bx.

In addition, in step S404, the liquid crystal control unit 140 calculates the luminance of the transmitted light of each pixel by the product of the amount of light irradiated to each pixel (the main irradiation amount (Ln-1)+the auxiliary irradiation amount (Lm-2)) and the transmittance (Bx) of each pixel.

For example, the amount of light irradiated to the pixel B4 of the liquid crystal panel 130 is 255 cd/m², which is the sum total of the main irradiation amount L2-1 by the light emission in the light emitting area 110-2, and the auxiliary irradiation amounts L1-2, L3-2 by the light emission in the light emitting area 110-1 and the light emitting area 110-3. Image data of the pixel B4 has a gradation value of 250, and the liquid crystal transmittance thereof is set as 250/255 from FIG. 4B, so the luminance of the transmitted light is calculated as 250 cd/m².

Moreover, the amount of light irradiated to the pixel A1 is 255 cd/m², which is the sum total of the main irradiation amount L1-1 by the light emission in the light emitting area 110-1, and the auxiliary irradiation amount L2-2 by the light emission in the light emitting area 110-2. Image data of the pixel A1 has a gradation value of 1, and the liquid crystal transmittance thereof is set as 1/255 from FIG. 4B, so the luminance of the transmitted light is calculated as 1 cd/m².

Further, the amount of light irradiated to the pixel B2 is 255 cd/m², which is the sum total of the main irradiation amount L1-1 by the light emission in the light emitting area 110-1, and the auxiliary irradiation amount L2-2 by the light emission in the light emitting area 110-2. Image data of the pixel B2 has a gradation value of 2, and the liquid crystal transmittance thereof is set as 2/255 from FIG. 4B, so the luminance of the transmitted light is calculated as 2 cd/m².

In this manner, it is found that when the amount of light emission in the light emitting area 110-2 is increased in order to make high the luminance of the transmitted light of the pixel B4 in a bright image, the influence of leakage light becomes large in the other light emitting areas.

In step S405, the liquid crystal control unit 140 determines whether the luminance of the transmitted light of each pixel is equal to or greater than the threshold value X. When the luminance of the transmitted light of a pixel is equal to or greater than the threshold value X, the liquid crystal control unit 140 goes to step S406, whereas when the luminance of the transmitted light is less than the threshold value X, the liquid crystal control unit 140 goes to step S407.

The way how the relation between the amount of color shift of the transmitted light and the color shift felt by the viewer changes according to the luminance of the transmitted light varies with the brightness of the surroundings of the liquid crystal display device, and the individual difference of the viewer. In other words, even if the luminance of the transmitted light is quite high, it may be difficult for the viewer to feel the color shift depending upon the viewer or viewing environment, or on the contrary, it may be easy for the viewer to feel the color shift even with low luminance. For that reason, in cases where the threshold value X is set from the viewpoint of reducing a strange or uncomfortable feeling due to the color shift for a larger number of viewers, the threshold value X is made low as much as possible. For example, the threshold value X is set to 0.01 cd/m².

On the other hand, in cases where the viewing environment is bright, even with a luminance of about 3 cd/m², it is felt sufficiently dark, for example, and hence, it is considered that even if the threshold value X is set to be higher than in the above-mentioned example, a strange or uncomfortable feeling can be suppressed for a lot of viewers. In this embodiment, from this point of view, the threshold value X is set to 3 cd/m². The setting of the threshold value is not limited to the example shown in this embodiment. In cases where the threshold value X of the luminance of the transmitted light is 3 cd/m², it is judged that the luminance of the transmitted light of the pixel A1 of the liquid crystal panel 130, being 1 cd/m², is less than the threshold value, and the processing of the flow goes to step S407. Similarly, a judgment is made for each of the other pixels as to whether the luminance of the transmitted light is equal to or greater than the threshold value.

For example, the luminance of the transmitted light of the pixel B4, being 250 cd/m², is determined to be equal to or greater than the threshold value, so the processing of the flow goes to step S406. In addition, the luminance of the transmitted light of the pixel B3, being 2 cd/m², is determined to be less than the threshold value, so the processing of the flow goes to step S407. In this manner, the liquid crystal control unit 140 detects those pixels for which the luminance of the transmitted light is equal to or more than the threshold value, i.e., those pixels for which an upper limit of the amount of color shift of the transmitted light under which the color shift felt by the viewer is within the allowable range becomes low.

In cases where it is judged in step S405 that the luminance of the transmitted light of a pixel is equal to or greater than the threshold value, then in step S406, the liquid crystal control unit 140 resets the transmittance of that pixel by using the transmittance setting parameters shown in FIG. 4C. For example, the pixel B4 has a luminance equal to or greater than the threshold value, so the transmittance thereof is reset by the use of the transmittance setting parameters in FIG. 4C. Here, note that in the case of this embodiment, the transmittance of the pixel B4 corresponding to a gradation value of 255 has the same value, even with the transmittance setting parameters in FIG. 4B, or with the transmittance setting parameters in FIG. 4C, and hence, as a result, the transmittance to be set does not change irrespective of whether the luminance of the pixel B4 is equal to or greater than the threshold value. However, this is because the transmittance setting parameters have been set as such by chance, and whether the transmittance to be set will change depending upon whether the luminance is equal to or greater than the threshold value is due to how to set the transmittance setting parameters corresponding to the luminance.

In step S407, the liquid crystal control unit 140 determines whether the settings of the transmittances for all the pixels of the liquid crystal panel 130 have been completed. In cases where the settings have not yet been completed, the liquid crystal control unit 140 returns to step S403, where the transmittances of those pixels for which the transmittances thereof have not yet been set. On the other hand, in cases where the settings have been completed, the liquid crystal control unit 140 goes to step S408, and ends the processing.

Here, along the flow chart in FIG. 5, reference will be made to the processing which is carried out in cases where the viewer has made an instruction to double the luminance of the liquid crystal display device.

For example, reference will be made to a case where the amount of light irradiated to each pixel of the liquid crystal panel 130 has been changed to 510 cd/m², i.e., twice the above-mentioned value of 255 cd/m².

In the processing to calculate the luminance of the transmitted light of each pixel in step S404, it is assumed that the amounts of light to be irradiated onto the pixels A3-A5, B3-B5, C3-C5 of the liquid crystal panel 130 by the light emission in the light emitting area 110-2 are 510 cd/m² for each pixel (main irradiation amount L1-1). In addition, the amounts of light to be irradiated onto the pixels A1, A2, A6, A7, B1, B2, B6, B7, C1, C2, C6, C7 by the light emission in the light emitting area 110-2 are assumed to be 506 cd/m² (auxiliary irradiation amount L1-2).

In the image data of FIG. 4A, the maximum gradation value among the pixels A1, A2, B1, B2, C1, C2 is 2. Also, the maximum gradation value among the pixels A6, A7, B6, B7, C6, C7 is 2. The light emitting areas 110-1, 110-3 of the light source 110 corresponding to those display areas of the liquid crystal panel 130 which include these pixels emit light with amounts of light emission corresponding to this maximum gradation value, so that the light is irradiated toward the liquid crystal panel 130. The amounts of light to be irradiated onto the pixels A1, A2, A6, A7, B1, B2, B6, B7, C1, C2, C6, C7 of the liquid crystal panel 130 by the light emission in the light emitting areas 110-1, 110-3 are assumed to be 4 cd/m² at each pixel (main irradiation amounts L1-1, L3-1). In addition, the amounts of light to be irradiated by the light emission in the light emitting areas 110-1, 110-3 onto the pixels A3-A5, B3-B5, C3-C5 are sufficiently small as compared with 510 cd/m² at each pixel, and hence are assumed to be 0 cd/m² (auxiliary irradiation amounts L1-2, L3-2). Accordingly, the amount of light irradiated to each of the pixels A1-C7 becomes 510 cd/m².

The pixel A1 of the liquid crystal panel 130 has a transmittance set as 1/255, so the luminance of the transmitted light therethrough is calculated to be 2 cd/m². In a similar manner, the luminance of the transmitted light through the pixel B4 is calculated to be 500 cd/m². Also, the luminance of the transmitted light through the pixel B2 is calculated to be 4 cd/m². In this manner, it is found that when the amount of light emission in the light emitting area 110-2 is increased in order to make high the luminance of the transmitted light through the pixel B4, the light amounts of leakage light leaking to the other light emitting areas change in accordance therewith.

In step S405, the luminance of the transmitted light through the pixel B2, being 4 cd/m², becomes equal to or greater than the threshold value of 3 cd/m², so the liquid crystal control unit 140 goes to step S406. With respect to the pixel B2, the light amount of the leakage light from the light emitting area 110-2 increases due to the increase in the luminance of the liquid crystal display device, so the upper limit of the amount of color shift of the transmitted light under which the color shift felt by the viewer is in the allowable range becomes low, thus giving rise to a possibility of sensing a strange or uncomfortable feeling.

In step S406, the liquid crystal control unit 140 sets the transmittance of the liquid crystal for the pixel B2 by the use of the transmittance setting parameters in FIG. 4C. That is, the image data of the pixel B2 has a gradation value of 2, and hence, the liquid crystal control unit 140 sets the individual transmittances of the subpixels 130R, 130G, 130B of the pixel B2 to 2/255, 2/255, and 1/255, respectively. As a result of this, an amount of color shift of the transmitted light through the pixel B2 from its target color becomes about 0, so that even if the luminance of the transmitted light becomes high and the viewer is sensitive to the color shift, it is possible to suppress the occurrence of a strange or uncomfortable feeling. In this manner, by carrying out color correction on those pixels for which the luminance of the transmitted light becomes equal to or greater than the threshold value, it is possible to reduce the strange or uncomfortable feeling of the viewer caused by feeling the color shift.

Similarly, the liquid crystal control unit 140 carries out color correction on the image inputted to the liquid crystal panel 130 for all the pixels according to the luminance of the transmitted light therethrough, and ends the processing.

As described above, in this embodiment, in cases where the luminance of the transmitted light increases to become equal to or greater than the threshold value in accordance with a change in the amount of leakage light leaking from those light emitting areas in which the amount of light emission is large to those light emitting areas in which the amount of light emission is small, color correction is carried out in such a manner as to decrease the amount of color shift of the transmitted light from the target color thereof. According to this, it is possible to suppress the occurrence of a strange or uncomfortable feeling due to the color shift at the time when the viewer looks at the image displayed on the image display apparatus which carries out local dimming. In particular, in cases where a high brightness light emitting area and a low brightness light emitting area are adjacent to each other, it is possible to suppress the occurrence of visually recognizable false color in a halo portion of the low brightness light emitting area due to leakage light from the high brightness light emitting area. In addition, in this embodiment, color correction is carried out in cases where the luminance of the transmitted light is equal to or greater than the threshold value, i.e., only in the case of the luminance at which the viewer becomes sensitive to color shift, as a result of which the execution of unnecessary color correction processing is suppressed. With this, it is possible to suppress an increase in processing load for color correction. Moreover, in this embodiment, in the transmittance control of the liquid crystal panel, the transmittance in the low gradation region in which color shift occurs in the color of the transmitted light therethrough is also used, thus making it possible to reduce the strange or uncomfortable feeling due to the color shift, without decreasing the number of luminance gradation steps.

In addition, in this embodiment, there has been described an example in which the transmittance at each pixel of the liquid crystal panel 130 is set by changing two kinds of transmittance setting parameters according to the relation between the luminance of the transmitted light and one threshold value, but three or more kinds of transmittance setting parameters may be changed over with one another, by the use of a plurality of threshold values. By doing so, it is possible to suppress the strange or uncomfortable feeling due to the color shift at the time when the viewer looks at the displayed image, in a more reliable manner.

Moreover, in this embodiment, there has been described an example in which the liquid crystal control unit 140 acquires information on the amount of light to be irradiated on the liquid crystal panel 130 from the light source control unit 120, but the method or way of acquiring the information on the amount of light to be irradiated on the liquid crystal panel 130 is not limited to this example. For example, provision may be made for a detection unit, such as an optical sensor, which detects the light to be irradiated onto the liquid crystal panel 130, wherein the information on the amount of light to be irradiated onto the liquid crystal panel 130 may be acquired from this detection result. In addition, provision may be made for a detection unit, such as an optical sensor, which detects the light transmitted through the liquid crystal panel 130, wherein the information on the luminance of the light transmitted therethrough may be acquired from this detection result. With the construction using such a detection unit, even if the light source for emitting light to transmit through the liquid crystal panel 130 is any arbitrary light source such as sunlight, for example, it is possible to reduce a strange or uncomfortable feeling due to color shift at the time when the viewer looks at an image, similar to this embodiment.

Further, in this embodiment, the light source 110 has been assumed to be able to irradiate a uniform light to the liquid crystal panel 130, but may be a light source of a directly under type backlight (downlight type backlight) which irradiates light in a non-uniform manner, e.g., in Lambert orientation. In this case, the strange or uncomfortable feeling felt by the viewer can be reduced by changing the transmittance setting parameters according to the luminance of the light transmitted through the liquid crystal panel, similar to this embodiment. For example, it is assumed that when the amount of light irradiated to the pixel B4 is 510 cd/m², the amount of light irradiated to the pixel B3 is decreased to 255 cd/m². Then, in cases where the transmittance of the pixel B3 is 2/255, the luminance of the transmitted light through the pixel B2 becomes 2 cd/m², and when the threshold value is set to cd/m², it is judged to be unnecessary to reset the transmittance by changing the transmittance setting parameters therefor.

Furthermore, in this embodiment, the image data displayed on the liquid crystal panel 130 has been stored in the storage unit 150, but provision may further be made for an image input unit which serves to receive an input of image data (image signal) from the outside, so that the same processing as in this embodiment is carried out at the time of displaying the image data thus inputted.

Still further, in this embodiment, there has been described an example in which the light source control unit 120 controls the amount of light emission of the light source 110 according to the maximum gradation value of the image data to be displayed. However, the construction may instead be such that the amount of light emission of the light source 110 can be changed by a user who operates a button, a volume knob, or the like provided on the liquid crystal display device, or a remote controller. In this case, too, the same effects as in this embodiment can be obtained by estimating or detecting a change in the luminance of the light transmitted through the liquid crystal panel accompanying a change in the amount of light emission of the light source 110, and by carrying out color correction in accordance therewith.

In addition, in this embodiment, there has been described an example in which the transmittance setting parameters used for setting the transmittance at each pixel of the liquid crystal panel 130 are selected according to the luminance of the transmitted light through each pixel. However, provision may further be made for a detection unit which can detect the light incident to the viewer's eyes, wherein the transmittance setting parameters may be changed according to the result of the detection. In this way, the transmittance can be set by the use of more optimal transmittance setting parameters for the viewer. For example, in cases where bright light as compared with the light from the light emitting areas corresponding to the display areas of a low gradation image is incident to the viewer's eyes, a color shift of the light transmitted through the liquid crystal panel from the light emitting areas becomes difficult to be perceived. For this reason, the threshold value X may be changed to a higher value. Also, in cases where light not so bright as compared with the light from the light emitting areas corresponding to the display areas of the low gradation image is incident to the viewer's eyes, the color shift of the light transmitted through the liquid crystal panel from the light emitting areas becomes easy to be perceived. Accordingly, the threshold value X may be changed to a lower value. The brightness of the light incident to the viewer's eyes can be obtained from a total amount of light emitted from the entire screen of the liquid crystal panel. The total amount of light emitted from the entire screen of the liquid crystal panel can be obtained from the brightness information of the image data to be displayed and the amount of light emission of the backlight. In addition, provision may further be made for a detection unit (a second detection unit) such as an outdoor light sensor which detects the brightness of outdoor light (environmental light), wherein the brightness of light incident to the viewer's eyes may be obtained from the result of the detection.

Moreover, in cases where the luminance of the high brightness light emitting area is high, it becomes difficult for the viewer to perceive a halo due to leakage light to the low brightness light emitting area. For that reason, in cases where the luminance of the high brightness light emitting area is high, the threshold value may be made high, and in cases where the luminance of the high brightness light emitting area is low, the threshold value may be made low. That is, the threshold value may be changed according to the luminance (the amount of light emission) in the high brightness light emitting area. For example, the threshold value may be changed according to the luminance of a light emitting area which is the highest in luminance (the largest in the amount of light emission) among a plurality of light emitting areas, in such a manner that the higher the luminance of the high brightness light emitting area, the higher the threshold value may be made. Alternatively, the threshold value may be changed depending on whether the luminance of the high brightness light emitting area is higher than a predetermined value.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), a micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD) or Blu-ray Disc (BD) (tm)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-056904, filed on Mar. 19, 2013, which is hereby incorporated by reference herein in its entirety.

What is claimed is:

1. An image display apparatus comprising:
a display unit having a plurality of pixels each composed of subpixels of a plurality of colors and being configured to display an image based on inputted image data by causing light from a light source to transmit through the subpixels at a transmittance set for each subpixel;
a setting unit configured to set the transmittance of each subpixel of said display unit according to a pixel value of each pixel of said image data; and
an acquisition unit configured to acquire the brightness of the light having transmitted through each pixel of said display unit;
wherein said setting unit corrects the transmittance of each subpixel in such a manner that with respect to a pixel of which the brightness of the transmitted light is equal to or greater than a threshold value, a difference between the color of the transmitted light and a target color based on the pixel value thereof becomes small.

2. The image display apparatus as set forth in claim 1, wherein said setting unit carries out said correction on a pixel at which the brightness of the transmitted light is equal to or greater than the threshold value, and which has a pixel value in a predetermined low gradation region.

3. The image display apparatus as set forth in claim 1, further comprising:
a light emitting unit as said light source configured to irradiate light to said display unit from a back face of said display unit.

4. The image display apparatus as set forth in claim 3, wherein said acquisition unit acquires the brightness of the transmitted light through each pixel based on an amount of light emission of said light emitting unit.

5. The image display apparatus as set forth in claim 3, wherein said light emitting unit is composed of a plurality of light emitting areas in which amounts of light emission thereof can be individually controlled; and
a control unit is further provided that is configured to control an amount of light emission in each light emitting area according to the brightness of an image displayed in each display area of said display unit corresponding to each light emitting area of said light emitting unit.

6. The image display apparatus as set forth in claim 5, wherein said acquisition unit acquires the brightness of the transmitted light through each pixel based on an amount of light emission in a light emitting area corresponding to a display area to which each pixel belongs.

7. The image display apparatus as set forth in claim 5, wherein said acquisition unit acquires the brightness of the transmitted light through each pixel based on an amount of light emission in a light emitting area corresponding to a display area to which each pixel belongs, and an amount of leakage light leaking to said light emitting area from light emitting areas adjacent to said light emitting area.

8. The image display apparatus as set forth in claim 1, further comprising:
a storage unit configured to store information on a correspondence relation between a pixel value and a transmittance of each subpixel thereof;
wherein said setting unit sets the transmittance of each subpixel based on said correspondence relation.

9. The image display apparatus as set forth in claim 8, wherein said storage unit stores information on a plurality of different correspondence relations according to the brightness of the transmitted light; and
said setting unit carries out said correction by changing over between said correspondence relations used for setting the transmittance of each subpixel according to whether the brightness of the transmitted light is equal to or greater than a threshold value.

10. The image display apparatus as set forth in claim 9, wherein said storage unit has stored information on a first correspondence relation and a second correspondence relation, wherein said second correspondence relation has a smaller difference between the color of the transmitted light and the target color based on the pixel value in comparison with said first correspondence relation, and said first correspondence relation has a higher accuracy in the gradation of transmittance in comparison with said second correspondence relation; and
said setting unit sets the transmittance of each subpixel by using said second correspondence relation in cases where the brightness of the transmitted light is equal to or greater than the threshold value, and said setting unit sets the transmittance of each subpixel by using said first correspondence relation in cases where the brightness of the transmitted light is less than the threshold value.

11. The image display apparatus as set forth in claim 1, further comprising:
a detection unit configured to detect the light to be irradiated to said display unit from said light source;
wherein said acquisition unit acquires the brightness of the transmitted light through each pixel based on a result of the detection by said detection unit.

12. The image display apparatus as set forth in claim 1, further comprising:
a detection unit configured to detect the light which is irradiated to said display unit from said light source to transmit through said display unit;
wherein said acquisition unit acquires the brightness of the transmitted light through each pixel based on a result of the detection by said detection unit.

13. The image display apparatus as set forth in claim 1, wherein said setting unit makes said threshold value high, in cases where the light incident to viewer's eyes is brighter as compared with the transmitted light from the pixels.

14. The image display apparatus as set forth in claim 1, wherein said setting unit makes said threshold value low, in cases where the light incident to viewer's eyes is darker as compared with the transmitted light from the pixels.

15. The image display apparatus as set forth in claim 13, further comprising:
a second detection unit configured to detect environmental light of said image display apparatus;
wherein said setting unit makes a comparison in brightness between the light incident to viewer's eyes and the transmitted light from the pixels based on a result of the detection by said second detection unit.

16. The image display apparatus as set forth in claim 1, wherein said threshold value is set based on a boundary brightness value between a brightness value at which photopic vision or mesopic vision occurs for a viewer, and a brightness value at which scotopic vision occurs for the viewer.

17. The image display apparatus as set forth in claim 1, wherein said pixels are each composed of subpixels of three primary colors of red, green and blue colors.

18. The image display apparatus as set forth in claim 17, wherein in cases where a achromatic color image is displayed, said setting unit corrects the transmittance of each subpixel in such a manner that with respect to a pixel of which the brightness of the transmitted light is equal to or greater than the threshold value, the transmitted light becomes achromatic color.

19. The image display apparatus as set forth in claim 1, wherein said display unit is a liquid crystal panel.

20. A control method for an image display apparatus comprising a display unit having a plurality of pixels each composed of subpixels of a plurality of colors and being configured to display an image based on inputted image data by causing light from a light source to transmit through the subpixels at a transmittance set for each subpixel, said method comprising:
setting the transmittance of each subpixel of said display unit according to a pixel value of each pixel of said image data; and
acquiring brightness of the light having transmitted through each pixel of said display unit;
wherein in said setting, the transmittance of each subpixel is corrected in such a manner that with respect to a pixel of which the brightness of the transmitted light is equal to or greater than a threshold value, a difference between the color of the transmitted light and a target color based on the pixel value thereof becomes small.
